(19) United States
(12) Patent Application Publication
(10) Pub. No.: US 2006/0132575 A1
(43) Pub. Date: Jun. 22, 2006

(54) Inkjet printer and recorded product produced thereby

(75) Inventor: Teruyuki Fukuda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC., Tokyo (JP)

(21) Appl. No.: 11/304,373

(22) Filed: Dec. 15, 2005

(30) Foreign Application Priority Data
Dec. 22, 2004 (JP) JP2004-370931

(51) Int. Cl. B41J 2/01

(52) U.S. Cl. 347/104

(57) ABSTRACT

An inkjet printer, comprises a conveying section to holding and conveying a recoding material, and an ink jet print head to jet an ink for the recoding material; wherein the conveyance section has and endless conveying member including an endless base member whose outer peripheral surface is covered with fluororesin and a sticky layer formed by a sticking tape transferred onto the outer peripheral surface of the endless base member, the sticking tape has not a substrate and the sticky layer contains a silicone polymer.

### BACKGROUND OF THE INVENTION

The present invention relates to an inkjet printer provided with a conveyance apparatus having an adhesive endless conveying member, and a recorded product produced by this inkjet printer.

The inkjet printer recording method provides simple creation of an image at reduced costs, and therefore, has been used in the field of a great variety of printing operations, for example, in photographing, printing, marking and other special forms of printing such as color filtering. In particular, excellent image quality comparable to that of the silver halide photography can be obtained, using the inkjet recording apparatus for emitting and controlling fine dots the ink characterized by an improved range of color reproduction, enhanced durability, and upgraded ink jetting properties, and the recording paper designed specifically for inkjet printing characterized by drastic improvement in ink absorbency, color development of the coloring material and surface glossiness. The current improvement of the image quality in the inkjet recording method can be implemented only when all of the three factors—the inkjet recording apparatus, ink and recording paper designed specifically for inkjet printing—have been developed to a required level.

Further, in recent years, attempts have been made to apply the aforementioned inkjet recording method to the textile printing of the fabric. This is because, in the field of textile printing, the inkjet recording method that does not require any prepressing process provides a great advantage in meeting the requirements of shorter delivery times and a production method for small batches of a variety of products.

Further, the aforementioned method uses only the amount of ink required for image formation, and therefore, provides environmental advantages of reduced waste liquid, as compared to the conventional method. Thus, this method can be said to be an excellent image formation method.

To get a uniform image in the inkjet textile printing, it is essential to ensure stable conveyance of such a product as a fabric, easily subjected to uneven deformation, on which an image is to be recorded, without such a product being deformed. For this purpose, an adhesive conveyance belt is used, for example.

For example, in one of the proposed methods, an adhesive organic solvent solution called the ground bonding agent is bonded on the conveyance belt and this is used as an adhesive belt (Patent Document 1). However, since an organic solvent is used for bonding, this method involves problems with safety and environmental suitability for the operator and others. Further, when the adhesive force has been reduced due to repeated use, the ground bonding agent must be applied again. This involves the burdensome procedure of applying the adhesive agent again after the adhesive agent has been scraped off using the organic solvent.

According to another proposal, a sticky tape having an sticky layer provided on both sides of the substrate is attached on the surface of an endless belt (Patent Document 2). As disclosed in the Patent Document 2, use of the double-coated sticky tape allows an sticky layer to be provided on the belt, without using an organic solvent, and permits easy replacement of the sticky layer when it has deteriorated.

However, when a sticky tape is to be applied on the conveyance belt completely without any gap, not a little overlap A occurs between the ends of the sticky tape, as shown in FIG. 1. To be more specific, when an sticky tape T is applied onto the endless conveyance belt B an overlap A inevitably occurs between the point where bonding of the sticky tape T has started TS and the point where the bonding has ended TE, if the sticky tape T is to be applied over the entire surface of the circumference of the conveyance belt B. On this overlap A, the cross section of the sticky tape T is more exposed. Especially when an sticky layer 2 is arranged on both sides of the substrate and the double-coated sticky tape T within the outside of each surface coated with a stripping member 1 is applied to the conveyance belt B, as shown in FIG. 2(a), the stripping members 1 on both sides of the double-coated sticky tape T are removed. After that, it is bonded on the substrate T for use when it is made of the substrate T and sticky layer 2. At the time of inkjet recording, ink will be attached to the recording material. The solvent in ink 1 spreads to reach the double-coated sticky tape T, and deformation 3′ of the substrate or separation of the sticky layer 2 occurs. Further, if ink enters the gap having created by deformation, the ink having penetrated cannot be removed even if cleaning has been carried out later. In this state, printing pressure and adhesion are again applied to the back surface of the recording material, with the result that the back surface of a new fabric will be contaminated, and a commercially viable product cannot be obtained. Such a problem has occurred in the conventional method.
[Patent Document 1] Official Gazette of Japanese Patent Tokkaisho 57-29676
[Patent. Document 2] Official Gazette of Japanese Patent Tokkai 2000-198970

### SUMMARY OF THE INVENTION

The object of the present invention is to solve the aforementioned problems and to provide an inkjet printer equipped with a conveyance apparatus using an adhesive endless conveyance member with an adhesive agent applied on the endless conveyance member when conveying a fabric or the like, wherein the aforementioned inkjet printer does not require use of an organic solvent and is protected against possible deformation caused by the ink located at the overlapped portion, image reproducibility, contamination on the back surface at the time of printing, or blurring of an image. The present invention also provides a recorded product produced by the aforementioned inkjet printer.

The aforementioned object can be achieved by the following structures:

(1) An inkjet printer, comprising:

a conveying section to holding and conveying a recoding material, and

an ink jet print head to jet an ink for the recoding material;

wherein the conveyance section has an endless conveying member including an endless base member being one of an endless belt or a roller whose outer peripheral surface is covered with fluororesin and a sticky layer formed by a sticking tape transferred onto the outer peripheral surface, the sticking tape has not a substrate and the sticky layer contains a silicone polymer.

(2) In the inkjet printer described in (1), the silicone polymer is an addition reaction curing type silicone polymer.

(3) In the inkjet printer described in (2), the addition reaction curing type silicone polymer contains (A) polydiorganosiloxane having two or more alkenyl groups in one molecule and (B) polyorganosiloxane having a SiH group and a blending ratio of the components (A)/(B) in-terms of weight is 20/80 to 80/20.

(4) In the inkjet printer described in (2) or (3), the addition reaction curing type silicone polymer contains (A) polydiorganosiloxane having two or more alkenyl groups in one molecule and (B) polyorganosiloxane having a SiH group and a mole ratio of the SiH group in the component (B) relative to the alkenyl group in the component (A) is 0.5 to 20.

(5) In the inkjet printer described in any one of (1) through (4), the recording material is a fabric.

(6) In the inkjet printer described in (5), an elongation at break in a longitudinal direction and a transverse direction of the fabric is 5% or more.

(7) In the inkjet printer described in any one of (1) through (6), the ink contains dispersion dye as a coloring material.

(8) A recording material, produced by an inkjet printer described in any one of (1) to (7).

The present invention provides an inkjet printer equipped with a conveyance apparatus using an adhesive endless conveyance member with an adhesive agent applied on the endless conveyance member when conveying a fabric or the like, wherein the aforementioned inkjet printer does not require use of an organic solvent and is protected against possible deformation caused by the ink located at the overlapped portion, image reproducibility, contamination on the back surface at the time of printing, or blurring of an image. The present invention also provides a recorded product produced by the aforementioned inkjet printer.

### BRIEF DESCRIPTION OF THE DRAWINGS

FIG. 1 is a schematic diagram representing an example of the case where a double-coated sticky tape is attached to an endless conveyance belt;

FIGS. 2(a) and 2(b) each is a schematic diagram representing the method of attaching a double-coated sticky tape to a conveyance belt and an example of the influence given by ink;

FIG. 3 is a schematic diagram representing an embodiment of the inkjet printer as an example of the inkjet recording apparatus for industrial use according to the present invention;

FIG. 4 is a schematic diagram representing an example of the structure of the double-coated sticky tape without substrate, according to the present invention; and

FIG. 5 is a schematic diagram representing an example of the pattern of applying the double-coated sticky tape to the conveyance belt.

### DETAILED DESCRIPTION OF THE PREFERRED EMBODIMENT

The following describes the best form of the embodiment of the present invention:

The inventors of the present invention have made an effort to solve the aforementioned problems, and have found out the following: An inkjet printer that does not require use of an organic solvent and is protected against possible deformation caused by the ink located at the overlapped portion, image reproducibility, contamination on the back surface at the time of printing, or blurring of an image, can be provided by using the inkjet printer designed for recording by emitting ink to the recording material, wherein the conveyance apparatus of the recording material has an adhesive endless conveyance member equipped with an sticky layer formed by transferring an sticky tape on an endless belt or roller surface, and the sticky tape has no substrate. The aforementioned finding has led the inventors of the present invention to achieve the present invention.

The inkjet printer of the present invention is used in the inkjet recording method wherein an image is recorded by emitting ink to a recording material.

The following describes the outline of the inkjet printer of the present invention with reference to an example of the inkjet textile printer.

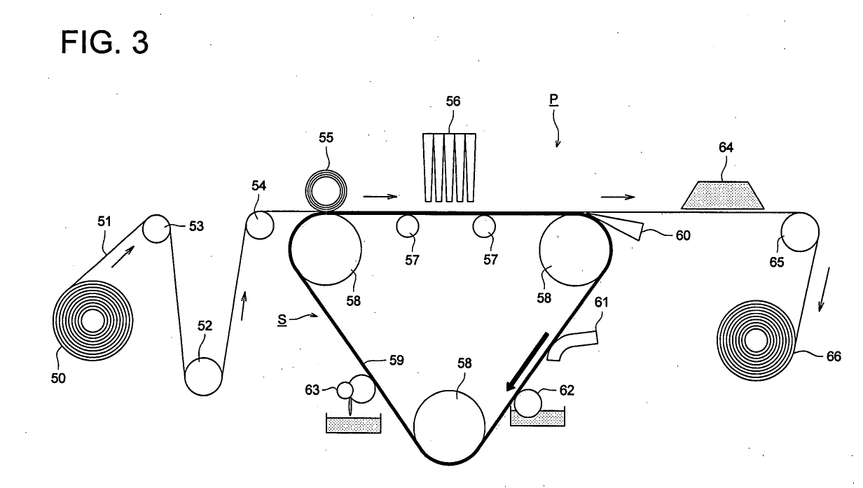

FIG. 3 is a schematic diagram representing an embodiment of the inkjet printer as an example of the inkjet recording apparatus for industrial use according to the present invention. The following describes the outline structure of the inkjet printer of the present invention with reference to FIG. 3. It should be noted, however, that the present invention is not restricted to the structures shown below. The present invention can be embodied in any variations with structural modifications and addition of structural elements that can be easily invented by those skilled in art, from the viewpoint of an inkjet recording apparatus for industrial use.

As shown in FIG. 3, the print medium as a recording material in the inkjet printer P is an appropriate fabric 51, and is wound as a roll-like laminate 50. The fabric 51 is fed out of the roll-like laminate 50. It is pressed against the surface of the adhesive conveyance belt 59 by a printing pressure roller 55 through intermediate rollers 53 and 54 and tension roller 52, and is fixed there. The fabric 51 in a fixed position is conveyed in the direction marked by an arrow. Ink is applied to the fabric 51 by a printing section having an inkjet print head 56, in the area between the platen rollers 57, whereby printing is carried out.

The printed fabric 51 is separated from the adhesive conveyance belt 59 by a fabric separation claw 60, and is dried by a drying heater 64. A heater that supplies hot air to the fabric 51, a heater that applies infrared ray for drying, or other heaters of appropriate form can be used as the drying heater 64. After having been dried, the fabric is wound by a winding roller 66.

The fabric conveyance member S has a conveyance roller 58, an endless conveyance belt 59 as a conveyance means wound and turned by the conveyance roller 58. After the fabric 51 has been separated from the site of the fabric separation claw 60, the conveyance belt 59 is roughly cleaned by a cleaning member 61. Then it is washed in water by a cleaning member 62, and moisture is removed by a wiping member 63. After that, the fabric 51 is again adhered and fixed in position by the printing pressure roller 55, and is printed by the printing section. This procedure is repeated and a pattern is recorded on the fabric 51 on a continuous basis.

In this case, the printed fabric is preferably wound while being dried sufficiently. Especially in the case of long-term printing on a long fabric having a length of 20 through 100 meters, a long stretch of the printed fabric is ejected. The printed fabric is continuously ejected onto the floor or like, and occupies a lot of space. If this is not wound, working safety cannot be ensured and the fabric may be subjected to unexpected contamination. Therefore, winding operation is essential after printing. During this operation, paper, cloth, vinyl and other media not related to printing can be inserted between fabrics so as to avoid the print-through. It goes without saying that, when the fabric is to be cut at some midpoint, or when the fabric is short, winding operation is not always essential.

In the inkjet printer having the aforementioned structure of the present invention, the conveyance apparatus has an adhesive endless conveyance member provided with an sticky layer formed by transferring a sticky tape on the surface of the endless tape or the roller. This sticky tape has no substrate.

In the inkjet printer, it is a common practice to increase the amount of the ink to be emitted, in order to increase the density of an image. However, when the recording material is a fabric, there is an empty space where there is no thread since the fabric is made of the warp and weft knitted together. If ink is emitted into this empty space, so-called printing-through will occur, wherein ink goes through the fabric to reach the back.

Therefore, in a commonly used conventional inkjet printer for textile printing, an endless conveyance member serving as a backing of the fabric and as an ink receiver is used, and this endless conveyance member is cleaned. Such an apparatus is employed in combination in the conventional inkjet printer.

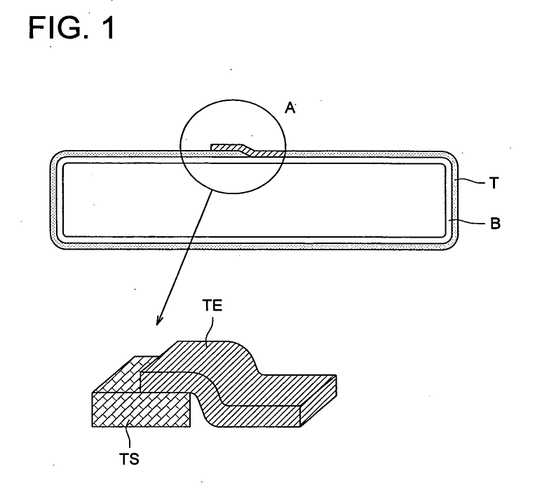

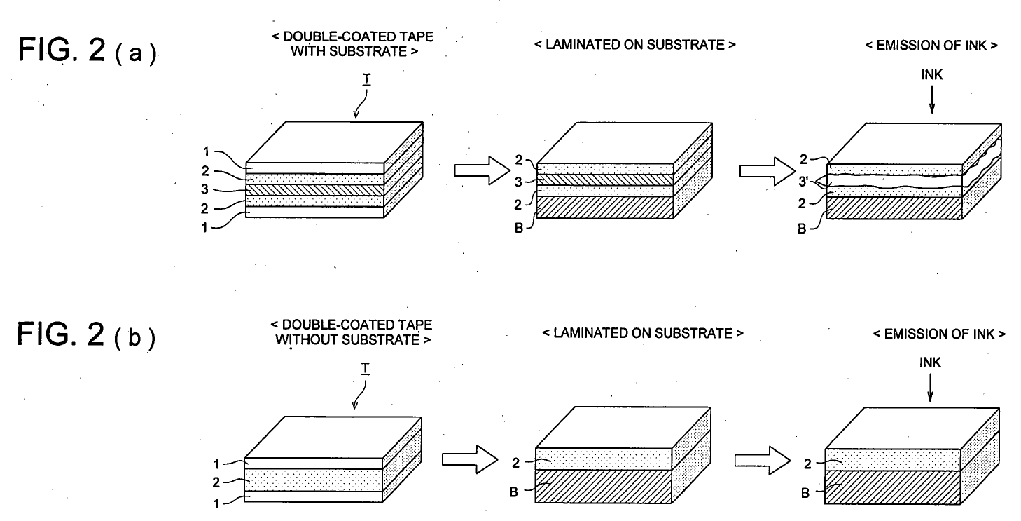

If a sticky tape containing a substrate is used as such an endless conveyance member, the problem of contamination on the adhesive surface can be solved by using the sticky layer made of silicone polymer or fluorine modified acryl resin. However, the substrate portion of the sticky tape is exposed on the cross section of the sticky layer as shown in FIG. 1. This always occurs at the time of bonding. As explained with reference to FIG. 2(a), the organic solvent and coloring agent of the ink penetrates the substrate portion of the sticky tape and causes deformation and contamination of the substrate.

As shown in FIG. 2(b), this problem can be solved by using the sticky tape independently formed by the sticky layer without containing any substrate. This arrangement ensures excellent durability since there is no substrate that might cause deformation or contamination.

The following describes the structure of the sticky tape that does not contain any substrate, according to the present invention:

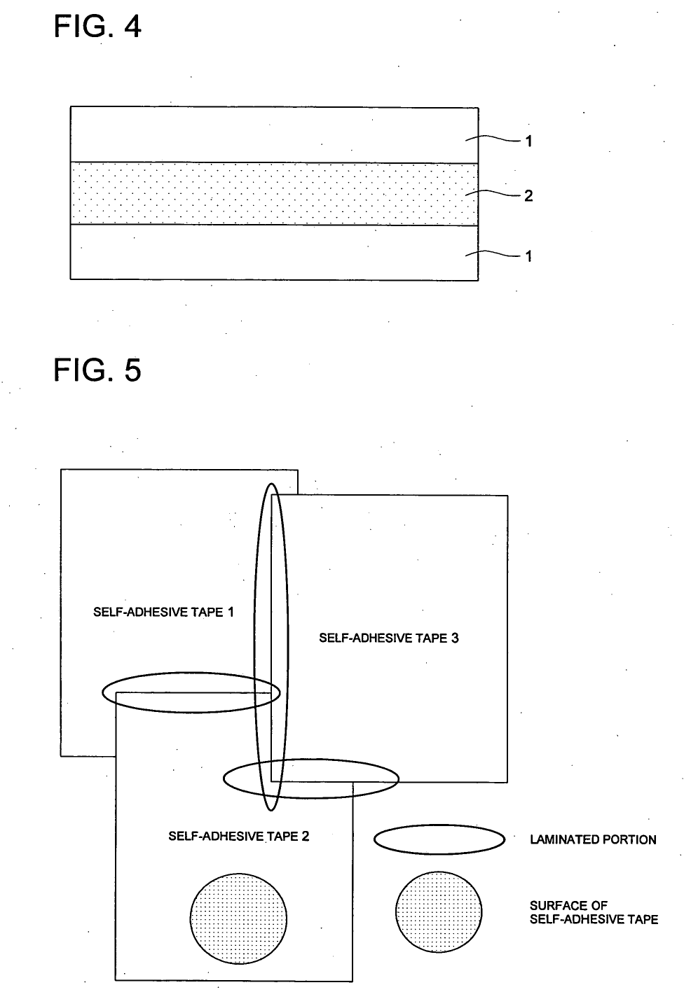

The sticky tape that does not contain any substrate, according to the present invention, is constructed in such a manner that the sticky layer 2 is sandwiched between a pair of stripping members 1, as shown in FIG. 4.

Moreover, as a material of the sticky layer according to the present invention, it is desirable to use a silicone base polymer, and as the silicone base polymer, an addition reaction curing type silicone polymer and a condensation polymerization curing type silicone polymer may be employed. In the present invention, the addition reaction curing type silicone polymer may be used more preferably especially. Moreover, the content of the silicone polymer in the adhesion layer is desirably 50% or more, and more preferably 80% or more.

The following compositions are preferably used for the addition reaction curing type silicone sticky layer coating liquid:
(A) Polydiorganosiloxane with two or more alkenyl groups contained in one molecule
(B) Polyorganosiloxane containing SiH group
(C) Inhibitor
(D) Platinum catalyst
(E) Conductive fine particulate

Here the component (A) is a polydiorganosiloxane with two or more alkenyl groups contained in one molecule. The polydiorganosiloxane with alkenyl groups can be exemplified by the substance expressed by the following formula (1).
R₍₃₋ₐ₎XₐSiO—(RXSiO)ₘ—(R₂SiO)ₙ—(RXSiO)ₚ—R₍₃₋ₐ₎XaSiO General formula (1)

In the general formula (1), R denotes the monovalent hydrocarbon having a carbon number of 1 through 10, and X denotes an organic group containing alkenyl group. “a” indicates an integer ranging from 0 through 3, and 1 is preferred. “m” indicates 0 or more. Therefore, if a=0, m is 2 or more. “m” and “n” each satisfy the equation 100≦m+n≦20,000, and “p” denotes 2 or more.

“R” denotes the monovalent hydrocarbon having a carbon number of 1 through 10. To put it more specifically, it includes alkyl group such as methyl group, ethyl group, propyl group and butyl group; cycloalkyl group such as cyclohexyl group; and aryl group such as phenyl group and tolyl group. Especially methyl and phenyl groups are preferably used.

The “X” denotes an organic group containing alkenyl group. It preferably contains a carbon number of 2 through 10. To put it more specifically, it includes vinyl group, aryl group, hexenyl group, octenyl group, acryloylpropyl group, acryloylmethyl group, methacryloyl propyl group, cyclohexenylethyl group and vinyloxypropyl group. Especially vinyl and hexenyl groups are preferred.

The polydiorganosiloxane is only required to have oil- and raw rubber-like properties. The component (A) preferably has a viscosity of 100 mpa·s or more at 25° C. It more preferably has a viscosity of 1000 mpa·s or more. The upper limit is not particularly restricted. To ensure easier blending with other components, it is preferred to select the viscosity so that the degree of polymerization will be 20,000 or less. One type of the component (A) can be used independently. Alternatively, two or more types can be used in combination.

The polyorganosiloxane containing the SiH as a component (B) is a crosslinking agent. It is possible to use the organohydropolysiloxane containing at least two hydrogen atoms bonded with silicon atom, preferably three hydrogen atoms, in one molecule, wherein this organohydropolysiloxane is shaped in a straight chain, or in a branched or cyclic form.

The component (B) includes the compounds expressed by the following general formula (2), without being restricted thereto.
H_{b}R¹_{(3-b)}SiO—(HR¹SiO)ₓ—(R¹₂SiO)_{y}—SiR¹_{(3-b)}H_{b} General formula (2)

In the general formula (2), “R¹” denotes the monovalent hydrocarbon having a carbon number of 1 through 6 that does not contain an aliphatic unsaturated bond. “b” indicates an integer from 0 through 3, and “x” and “y” each denote integers. They show the numbers where the viscosity of this organohydropolysiloxane at 25° C. is 1 through 5,000 mpa·s.

The viscosity of this organohydropolysiloxane at 25° C. is preferably 1 through 5,000 mpa·s, more preferably 5 through 1,000 mPa·s. A mixture of two or more types can be used.

Crosslinking by addition reaction occurs between the component (A) and component (B). The gel fraction of the sticky layer subsequent to curing depends on the percentage of crosslinking components.

The amount of component (B) to be used is preferably determined in such a manner that the mole ratio of the SiH group in the component (B) relative to the alkenyl group in the component (A) will be 0.5 through 20, more preferably 0.8 through 15. If this value is less than 0.5, crosslinking density will be reduced. This will result in poorer retaining capacity. If the value is more than 20, the adhesive strength and tackiness will be reduced. This will reduce the time when the processing solution is available in some cases.

To improve the heat resistance such as heat retaining capacity and the resistance to solvent such as control of the solvent penetration, the percentage of the crosslinking component in the composition should be increased. However, this is increased excessively, the adhesive force or film flexibility will be reduced in some cases. To overcome such difficulties, the blending ratio of the components (A)/(B) in terms of mass is preferably 20/80 through 80/20, more preferably 45/55 through 70/30. If the blending ratio of the component (A) is less than 20/80, adhesive properties such as adhesive strength and tackiness will be reduced. Further, if it is more than 80/20, sufficient heat resistance cannot be ensured.

The component (C) is an addition reaction inhibitor. It is added to ensure that the processing solution will not be thickened or gelated prior to heating or curing, when the silicone sticky layer coating liquid are, blended and are coated on the substrate.

The following describes the specific examples of the component (C):

3-methyl-1-butyne-3-ol

3-methyl-1-pentine-3-ol

3,5-dimethyl-1-hexyne-3-ol

1-ethynylcyclohexanol

3-methyl-3-trimethylcyloxy-1-butyne

3-methyl-3-trimethylcyloxy-1-pentine

3,5-dimethyl-3-trimethylcyloxy-1-hexyne

1-ethynyl-1-trimethylcyloxycyclohexane

bis(2,2-dimethyl-3-butynoxy)dimethylsilane

1,3,5,7-tetramethyl-1,3,5,7-tetravinylcyclotetrasiloxane

1,1,3,3-tetramethyl-1,3-divinyldisiloxane

The amount of the component (C) used in blending is preferably 0 through 0.5 parts by mass, more preferably 0.05 through 2.0, with respect to 100 parts by mass of the total of the components (A) and (B). If the value exceeds 5.0 parts by mass, curing property will be reduced.

The component (D) is a platinum catalyst. It includes platinic acid chloride, alcohol solution of platinic acid chloride, reaction product between platinic acid chloride and alcohol, reaction product between platinic acid chloride and olefin compounds, and reaction product between platinic acid chloride and siloxane containing vinyl group.

The amount of the component (D) as platinum to be added is preferably 1 through 5,000 ppm, more preferably 5 through 2,000 ppm, relative to the total amount of the compounds (A) and (B). If this value is less than 1 ppm, curing efficiency, crosslinking density and retaining capacity will be reduced in some cases. If the value exceeds 5,000 ppm, it will reduce the time when the processing solution is available, in some cases.

To provide antistatic measures, the conductive fine particle as the component (E) can be added to the aforementioned addition reaction curing type silicone sticky layer coating liquid. To put it more specifically, it includes metallic powder such as silver powder, copper powder, gold powder, nickel powder, aluminum powder, iron powder, and solder powder. It also includes such conductive resin as carbon black, carbon nanotube, fullerene and polyacetylene. It further includes such inorganic particles as hollow glass beads, silica and titanium oxide. Still further, it includes conductive particles such as silver plated silica, gold plated silica, gold plated glass beads, silver plated polyacrylate fine particle, produced by metal-plating the surface of such resin particles as polyacrylate, epoxy resin, silicone resin and fluorine resin. Of these, silver powder, copper powder, carbon black, gold plated silica, and silver plated silica are preferably used.

No special restriction is imposed on the form of the conductive fine particle of component (E). The conductive fine particle can be spherical, branched or needle-shaped. Similarly, the particle diameter is not restricted. It is preferred that the maximum particle diameter should not exceed 1.5 times the thickness of the coating. If it exceeds this value, excessively large protrusions of the conductive fine particles will be produced on the surface of the coating of sticking agent. These portions tend cause uplifting from the coated member.

In the present invention, when the silver powder is used as the conductive fine particle used in the conductive silicone sticky layer coating liquid, the average particle diameter is preferably 0.1 through 150 μm, more preferably 0.15 through 80 μm. If the average particle diameter is smaller than 0.1 μm, there will be a drastic reduction in conductivity. If the average particle diameter is greater than 150 μm, satisfactory adhesive property will not ensured.

The amount of the component (E) to be added is preferably determined in such a manner that the ratio of component (E) relative to the total of components (A) and (B) will be 97/3 through 50/50. If the ratio of the component (E) is smaller than 97/3, sufficient conductivity cannot be ensured. If it is greater than 50/50, adhesive strength will be reduced, with the result that adhesive properties will deteriorate, in some cases.

In addition to the aforementioned components, any desired component can be added to the silicone sticky layer coating liquid. For example, it is possible to add non-reactive polyorganosiloxane such as polydimethylsiloxane and polydimethyldiphenylsiloxane; toluene for reducing viscosity at the time of coating; aromatic solvent such as xylene; aliphatic solvent such as hexane, octane and isoparaffin; ketone solvent such as methylethylketone and methylisobutylketone; ester solvent such as ethyl acetate and isobutyl acetate; ether solvent such as diisopropylether and 1,4-dioxane or solvent formed by mixture thereof; antioxidant; dye; and pigment. It should be noted that solvent is normally used to reduce the viscosity of the composition and to facilitate coating.

The silicone sticking agent composition blended in the aforementioned manner is coated on various substrates and is cured under predetermined conditions, whereby the sticky layer is formed.

Generally, as an example of the silicone sticking agent (silicone agglutinant), a solvent type, a solventless type, and an emulsion type may be used. Moreover, by adding and mixing other aid (supplementary agent) if needed, and it can be produced as a coating liquid. As the other aid, a viscosity reducing agent, a thickening agent, a pH adjustor, an anti-foaming agent, a disinfectant mildewproofing agent, a pigment, an inorganic filler, a stabilizer, a wetting agent, flexibility promoting substance, etc. can be listed.

The following describes a separation film or separation paper as a separation member coated with sticking agent and held in position.

The separation film or separation paper is a substrate for forming an sticky layer and for protecting the sticky layer against foreign substances such as dusk and dirt when the sticking agent is stored. In an example of the separation film, a film made of such resins as polyethyleneterephthalate, polyebutyleneterephthalate, polycarbonate and polyarylate is used as a substrate. One side or both sides of this substrate in contact with the sticky layer is provided with mold releasing treatment. The example of the separation paper is the same as that of the separate film, except that the substrate is made of paper.

The following shows the examples of the coating solution for providing mold releasing treatment for the purpose of manufacturing the separation film and separation paper. In the DEHESIVE series of Asahi Kasei Wacker Silicone Co., Ltd., the examples of non-solvent type coating solutions are 636, 919, 920, 921 and 924. The examples of emulsion type coating solutions are 929, 430, 440, 39005 and 39006. The example of the silicone for separation paper by GE Toshiba Silicone Co., Ltd. are TPR6500, TPR6501, UV9300, UV9315, XS56-A2775, XS56-A2982, TPR6600, TPR6605, TPR6604, TPR6705, TPR6722, TPR6721, TPR6702, XS56-B3884, XS56-A8012, XS56-B2654, TPR6700, TPR6701, TPR6707, TPR6710, TPR6712, XS56-A3969, XS56-A3075, and YSR3022.

For the separation film and separation paper, the mold releasing agent is generally selected according to a desired sticking agent. Accordingly, there are not many products commercially available for general use. The separation film and separation paper applicable to the present invention can be enumerated as follows: The separation film is exemplified by the A50 Liner by Teijin DuPont Film Inc. An example of the separation paper is the Release by Hagawa Paper Manufacturing Co., Ltd.

Coating of the sticky layer on the separation paper is provided by a roll coater, blade coater, bar coater, air knife coater, gravure coater, reverse coater, die coater, lip coater, spray coater, comma coater and others. If required, smoothing, drying, heating and exposure to electronic rays such as ultraviolet rays are carried out, whereby an sticky layer is formed.

The thickness of the sticky layer is normally 3 through 100 μm, preferably 5 through 60 μm although it varies according to the type of the sticking agent.

The examples of the commercially available double-coated sticky tape, without substrate, applicable to the present invention are ARclear 8932 and ARclad 7876 by Adhesived Research Inc., and No. 7470 by Teraoka Seisakujo Co., Ltd.

Next, explained will be a method in which a sticky tape without a substrate is pasted up on an endless transport member by multilayer accumulation to prepare a Sticky endless transport member.

First the adhesive surface of a sticky tape without a substrate, a delaminating member on the one side of which has been peeled off, is pasted up, for example, on an endless belt as an endless transport member. Subsequently, a delaminating member on the other surface is peeled off to expose the Sticky surface.

An endless transport member utilized in this invention includes a transport roller and an endless belt. Among them, an endless transport member is preferably an endless belt, the surface of which has been covered with a fluororesin, in view of furthermore exhibiting the aimed effects of this invention.

As a transport roller applicable to this invention, any form such as a cylindrical form, an elliptical column form and a polygonal form is possible provided it allows rotational transportation, and it may be preferable in view of furthermore exhibiting the aimed effects of this invention that the surface of them is covered with a fluororesin.

Further, as an endless belt substrate utilized in this invention, there are one comprising a single layer of a film form and the other in which a core material is arranged inside or outside of film. As a material-to form film, fluororesin may be preferable with respect to prevention of contamination caused by ink.

A core material includes such as metal and synthetic fiber, and synthetic fiber includes such as glass fiber and aramid fiber. In this invention, glass fiber is preferred with respect to flexibility and durability of a substrate, and the surface is preferably further covered with fluororesin for the purpose of prevention of friction with a transport roller at the time of transportation. The covering with fluororesin can be performed by immersing a glass fiber belt in fluororesin dispersion and by heating the belt, after having been pulled up, at 400° C. for 15 minutes, whereby fluororesin being fused fixed on glass fiber.

A well-known fluororesin can be uses widely as the fluororesin preferably used in the present invention. Concretely, PTFE (polytetrafluoroethylene) known in the name of a Teflon (registered trademark) (Du Pont), FEP (par fluoroethylene propene copolymer), PFA (perfluoroalkoxyalkane) and tetrafluoroethylene-ethylene copolymer (ethylene-tetrafluoroethylene copolymer) and ECTFE (ethylene-chlorotrifluoroethylene copolymer), FVDF (poly fluoridationvinylidene), PCTFE (the poly chlorotrifluoroethyne), TFE/PDD (tetrafluoroethylene-par fluorodioxo copolymer), etc. are raised. Especially, it is desirable to use PTFE.

Next, a material to be recorded, ink, to which an inkjet printer of this invention is applied, and an inkjet printing process as a typical example will be explained.

A material to be recorded which is utilized at the time of image printing by an inkjet printer of this invention is not specifically limited, however, cloth is preferred with respect to sufficient exhibition of the effects of this invention.

Materials of cloth preferably utilized in this invention include cotton, linen, wool, silk, rayon, kyupura, polynosic, polyester, nylon, acryl, vinylon and mixings thereof.

Since cloth is generally prepared by suitably selecting such as a type of yarn, a thickness of yarn, a fabric and a mixing ratio so as to obtain the handling of cloth aimed by a printing manufacturer, there is no general product; however, examples, which are listed from dyeing testing fibers of Shikisen Co., Ltd., include such as calico, broad, twill, satin, knit, smooth, ponchroma, flannel and canvas as cotton; such as (ramie) broad as linen; such as mousseline, tropical and serge as wool; such as habutae, seika palace as silk; such as taffetas, staple fiber mousseline and fujiet as rayon; such as taffetas as kyupura; such as broad as polynosic; such as plain weave as Tencel; such as plain weave as Lyocell; such as taffetas as diacetate; such as taffetas, toropical, amundsen, spinning yarn cloth, Tetlex, georgette, crepe.decin, silk gause, jersey, doublepike and car sheet as polyester; such as traysy and samia as new synthetic fiber; such as knit smooth as cation dyeable polyester; such as taffetas, silk gause and jersey as nylon 6; such as jersey as nylon 66; such as moussline and jersey as acryl; such as broard as vinylon; such as polyester 65/cotton 35 broard, polyester 65/cotton 35 twill, polyester 50/cotton 50 knit smooth and polyester 65/rayon 35 plain weave as mixing; such as polyurethane 20/polyester 80 knit as cross knit; such as AATCC Style 1, 10 and SDC as multi-fiber cloth.

In the case of being applied to an inkjet printer of this invention, specifically the effect is significantly exhibited when stretchable cloth such as knit is precisely pasted up on a belt. Among them, to utilize cloth having ductility at a breaking point of not less than 5% is effective. Generally, since cloth having a good stretchable property to have ductility at a breaking point of not less than 5% is liable to cause wrinkles at the time of manufacturing the cloth, and is pasted up while being sufficiently stretched at the time of being precisely pasted up, gaps between fibers are generated to easily cause print through, however, stable transportation is possible, even with cloth provided with characteristics as described above, by applying a transport member provided with a self-sticky layer defined by this invention.

Cloth having ductility as described above includes knit smooth and ponchroma as cotton; such as jersey and double pique as polyester; such as knit smooth as cation dyeable polyester; such as jersey as nylon 6; such as jersey as nylon 66; such as jersey as acryl; polyester 50/cotton 50 knit smooth as mixing and such as polyurethane 20/polyester 80 as cross knit.

The reason why an inkjet printer of this invention is preferably utilized for the before-mentioned stretchable cloth is considered as follows.

In inkjet image recording, the striking quantity of ink directly influences the image density. Therefore, it is necessary to increase the ink strike quantity to obtain a printed material having a high density and a high quality, however, the rate of ink to soak into cloth is behind the rate of the ink to be applied when ink is struck on non-stretchable cloth, resulting in unification of an ink liquid drop each other to generate bleeding in the image. Further, in addition to this, there was a problem that image bleeding along fiber which was called as feathering, was generated when a fine line was drawn, whereby a desired fine line could not be obtained. By this reason, heretofore, bleeding has not been avoided in a high density print.

However, in this invention, by stretching and extending cloth having a ductility of not less than 5% in advance to spread the mesh (the space portion), ink absorption rate is increased so that bleeding has been significantly decreased. Thereby, it becomes possible to obtain a printed material having a higher density and a higher image quality than ever before.

In the case of an inkjet printing method according to this invention, to obtain a uniformly dyed material, it is preferable to wash out such as natural impurities (such as oil and fat, wax, pectin and natural dye), residuals of agents, which had been utilized in manufacturing process of the cloth, and dirt adhered on the fiber of cloth, before the cloth is pre-treated with water-soluble polymers. Cleaning agents utilized for washing include alkaline agents such as sodium hydroxide and sodium carbonate; surfactants such as anionic surfactants and nonionic surfactants; and enzyme.

In an inkjet printing method according to this invention, a pre-treatment solution is applied on cloth by an inkjet method (a pre-treatment process); thereafter, an image is formed on the cloth, which contains fiber capable of being dyed with disperse dye or pigment, utilizing ink by an inkjet method (an ink application process); the cloth having been applied with ink is heat treated (a coloring process); and further the cloth having been heat treated is washed to complete printing on the cloth, whereby a printed material is prepared.

In a pre-treatment process according to this invention, it is preferable to apply the cloth with a pre-treatment agent by such as a pad method, a coating method or a spray method.

As a pre-treatment method, a method suitable for the fiber material and the ink may be selected from those well known in the art such as to pre-treat cloth with water-soluble polymers, and it is not specifically limited. For example, by utilizing cloth having been applied with at least one substance, which is selected from a group comprising water-soluble metal salt, polycation compounds, water-soluble polymer, surfactants and water repelling agents, of 0.2-50 weight %, it is possible to sufficiently prevent bleeding, and to print a high precision image on the cloth.

Specific examples of water-soluble polymer, which are utilized as a pre-treatment agent, will now be listed. Natural water-soluble polymer includes starches such as corn and wheat, cellulose derivatives such as carboxymethyl cellulose, methyl cellulose and hydroxyethyl cellulose, polysaccharides such as sodium arginate, gur gum, tamarind gum, loucast bean gum and gum arabi, protein substances such as gelatin, casein and keratin; and synthetic water-soluble polymer includes polyvinyl alcohol, polyvinyl pyrrolidone and acrylic polymer. As surfactants, for example, anionic, cationic, amphoteric and nonionic types can be utilized, and typically, anionic surfactants include such as higher alcohol sulfuric ester salt and sulfonate of naphthalene derivatives; cationic surfactants include such as quaternary ammonium salt; amphoteric surfactants include such as imidazoline derivatives; nonionic surfactants include polyoxyethylene alkylether, polyoxyethylene propylene block polymer, sorbitan fatty acid ester, polyoxyethylene sorbitan fatty acid ester and ethylene oxide adducts of acetylene alcohol. Further, water repelling agents include, for example, those of a silicone type, a fluorine type and a wax type. These water-soluble polymer and surfactants, which are applied on cloth in advance, are preferably stable against heat not to cause dirt due to such as tar formation at the time of inkjet printing and coloring at high temperature. Further, these water-soluble polymer and surfactants, which are applied on cloth in advance, are preferably easily removed by a washing treatment after inkjet printing and coloring at high temperature.

Further, in inkjet ink for printing utilized at the time of dyeing by a high temperature vapor heating method described later, or in cloth utilized in printing, a dyeing aid is preferably contained.

A dyeing aid is provided with a function to form a co-fused mixture with water, which is condensed on cloth at the time of vapor heating of printed cloth, and to restrain the water amount to be re-vaporized resulting in shortening of time for temperature raising. Further, this co-fused mixture is provided with a function to dissolve dye on fiber and to accelerate a diffusion rate of the dye into the fiber. A dyeing aid includes urea. The dyeing aid may be applied on cloth in advance or may be contained in a pre-treatment solution.

In a pre-treatment solution, a dissolved gas may become a cause to disturb resolution and sharpness of the printed matter or to generate minute air bubbles. A method to degas a dissolved gas from a liquid is classified roughly into a method to degas by a physical method such as boiling and pressure reducing and a chemical method to incorporate an absorbing agent in a liquid. In this invention, degassing may be preformed by any method. Specifically, a method, in which a liquid is passed through the inside of a hollow fiber layer and reducing the pressure of the outside surface of the hollow fiber layer whereby dissolved gas in a liquid is transmitted and eliminated, is preferred with respect to efficient elimination of a dissolved gas without affecting physical properties of a liquid.

Next, ink utilized in an inkjet printing method according to this invention will be explained.

In this invention, ink contains at least a colorant, a water-soluble organic solvent and water. A colorant includes, for example, disperse dye, reactive dye, acid dye, direct dye and oil-soluble dye, however, among them, disperse dye is preferably utilized.

In the following, specific compounds of a colorant preferably utilized in this invention will be shown; however, this invention is not limited to these exemplified compounds.

Disperse dye preferably utilized in this invention includes such as C.I. Disperse Yellow; 3, 4, 5, 7, 9, 13, 23, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 160, 162, 163, 164, 165, 179, 180, 182, 183, 184, 186, 192, 198, 199, 202, 204, 210, 211, 215, 216, 218, 224, 227, 231, 232,

C.I. Disperse Orange; 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, 142,

C.I. Disperse Red; 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328,

C.I. Disperse Violet; 1, 4, 8, 23, 26, 27, 28, 31, 33, 35, 36, 38, 40, 43, 46, 48, 50, 51, 52, 56, 57, 59, 61, 63, 69, 77,

C.I. Disperse Green; 9,

C.I. Disperse Brown; 1, 2, 4, 9, 13, 19,

C.I. Disperse Blue; 3, 7, 9, 14, 16, 19, 20, 26, 27, 35, 43, 44, 54, 55, 56, 58, 60, 62, 64, 71, 72, 73, 75, 79, 81, 82, 83, 87, 91, 93, 94, 95, 96, 102, 106, 108, 112, 113, 115, 118, 120, 122, 125, 128, 130, 139, 141, 142, 143, 146, 148, 149, 153, 154, 158, 165, 167, 167:1, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333,

C.I. Disperse Black 1, 3, 10, 24.

In an inkjet printing method utilizing disperse dye, in the case of performing coloration at high temperature treatment, disperse dye having an excellent sublimation resistance is preferably selected not to cause contamination by sublimation of dye onto such as a machine and a white background of cloth.

Reactive dye preferably utilized in this invention includes such as C.I. Reactive Yellow; 2, 3, 7, 15, 17, 18, 22, 23, 24, 25, 27, 37, 39, 42, 57, 69, 76, 81, 84, 85, 86, 87, 92, 95, 102, 105, 111, 125, 135, 136, 137, 142, 143, 145, 151, 160, 161, 165, 167, 168, 175, 176, C.I. Reactive Orange; 1, 4, 5, 7, 11, 12, 13, 15, 16, 20, 30, 35, 56, 64, 67, 69, 70, 72, 74, 82, 84, 86, 87, 91, 92, 93, 95, 107,

C.I. Reactive Red; 2, 3, 3:1, 5, 8, 11, 21, 22, 23, 24, 28, 29, 31, 33, 35, 43, 45, 49, 55, 56, 58, 65, 66, 78, 83, 84, 106, 111, 112, 113, 114, 116, 120, 123, 124, 128, 130, 136, 141, 147, 158, 159, 171, 174, 180, 183, 184, 187, 190, 193, 194, 195, 198, 218, 220, 222, 223, 226, 228, 235,

C.I. Reactive Violet; 1, 2, 4, 5, 6, 22, 23, 33, 36, 38,

C.I. Reactive Blue; 2, 3, 4, 7, 13, 14, 15, 19, 21, 25, 27, 28, 29, 38, 39, 41, 49, 50, 52, 63, 69, 71, 72, 77, 79, 89, 104, 109, 112, 113, 114, 116, 119, 120, 122, 137, 140, 143, 147, 160, 161, 162, 163, 168, 171, 176, 182, 184, 191, 194, 195, 198, 203, 204, 207, 209, 211, 214, 220, 221, 222, 231, 235, 236,

C.I. Reactive Green; 8, 12, 15, 19, 21,

C.I. Reactive Brown; 2, 7, 9, 10, 11, 17, 18, 19, 21, 23, 31, 37, 43, 46,

C.I. Reactive Black 5, 8, 13, 14, 31, 34, 39.

Acid dye preferably utilized in this invention includes such as C.I. Acid Yellow; 1, 3, 11, 17, 18, 19, 23, 25, 36, 38, 40, 4.0:1, 42, 44, 49, 59, 59:1, 61, 65, 67, 72, 73, 79, 99, 104, 110, 159, 169, 176, 184, 193, 200, 204, 207, 215, 219, 219:1, 220, 230, 232, 235, 241, 242, 246,

C.I. Acid Orange; 3, 7, 8, 10, 19, 22, 24, 51, 51S, 56, 67, 74, 80, 86, 87, 88, 89, 94, 95, 107, 108, 116, 122, 127, 140, 142, 144, 149, 152, 156, 162, 166, 168,

C.I. Acid Red; 1, 6, 8, 9, 13, 18, 27, 35, 37, 52, 54, 57, 73, 82, 88, 97, 97:1, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, 415,

C.I. Acid Violet; 17, 19, 21, 42, 43, 47, 48, 49, 54, 66, 78, 90, 97, 102, 109, 126,

C.I. Acid Blue; 1, 7, 9, 15, 23, 25, 40, 61:1, 62, 72, 74, 80, 83, 90, 92, 103, 104,. 112, 113, 114, 120, 127, 127:1, 128, 129, 138, 140, 142, 156, 158, 171, 182, 185, 193, 199, 201, 203, 204, 205, 207, 209, 220, 221, 224, 225, 229, 230, 239, 258, 260, 264, 277:1, 278, 279, 280, 284, 290, 296, 298, 300, 317, 324, 333, 335, 338, 342, 350,

C.I. Acid Green; 9, 12, 16, 19, 20, 25, 27, 28, 40, 43, 56, 73, 81, 84, 104, 108, 109,

C.I. Acid Brown; 2, 4, 13, 14, 19, 28, 44, 123, 224, 226, 227, 248, 282, 283, 289, 294, 297, 298, 301, 355, 357, 413,

C.I. Acid Black; 1, 2, 3, 24, 24:.1, 26, 31, 50, 52, 52:1, 58, 60, 63, 63S, 107, 109, 112, 119, 132, 140, 155, 172, 187, 188, 194, 207, 222.

Direct dye preferably utilized in this invention includes such as C.I. Direct Yellow; 8, 9, 10, 11, 12, 22,.27, 28, 39, 44, 50, 58, 86, 87, 98, 105, 106, 130, 137, 142, 147, 153,

C.I. Direct Orange; 6, 26, 27, 34, 39, 40, 46, 102, 105, 107, 118,

C.I. Direct Red; 2, 4, 9, 23, 24, 31, 54, 62, 69, 79, 80, 81, 83, 84, 89, 95, 212, 224, 225, 226, 227, 239, 242, 243, 254,

C.I. Direct Violet; 9, 35, 51, 66, 94, 95,

C.I. Direct Blue; 1, 15, 71, 76, 77, 78, 80, 86, 87, 90, 98, 106, 108, 160, 168, 189, 192, 193, 199, 200, 201, 202, 203, 218, 225, 229, 237, 244, 248, 251, 270, 273, 274, 290, 291,

C.I. Direct Green; 26, 28, 59, 80, 85,

C.I. Direct Brown; 44, 44:1, 106, 115, 195, 20 9, 210, 212:1, 222, 223,

C.I. Direct Black; 17, 19, 22, 32, 51, 62, 108, 112, 113, 117, 118, 132, 146, 154, 159, 169.

Pigment preferably utilized in this invention includes such as carbon black, C.I. Pigment Yellow;. 1, 3, 12, 13, 14, 16, 17, 43, 55, 74, 81, 83, 109, 110, 120, 138, 150,

C.I. Pigment Orange; 13, 16, 34, 43,

C.I. Pigment Red; 2, 5, 8, 12, 17, 22, 23, 41, 112, 114, 122, 123, 146, 148, 149, 150, 166, 170, 220, 238, 245, 258,

C.I. Pigment Violet; 19, 23,

C.I. Pigment Blue; 15, 15:1, 15:3, 15:4, 15:5, 15:6, 29,

C.I. Pigment Brown; 22,

C.I. Pigment Black; 1, 7,

C.I. Pigment White 6.

In this invention, the content of a colorant contained in ink is preferably 0.1-20 weight % and more preferably 0.2-13 weight %.

A water-soluble organic solvent utilized in ink according to this invention includes, for example, those similar to water-soluble organic solvents utilizable in the pre-treatment solution described above. The amount of a water-soluble organic solvent is preferably 10-60 weight % against the total ink weight.

A surfactant utilized in ink according to this invention includes, for example, those similar to surfactants utilizable in the pre-treatment solution described above.

In the case of utilizing these surfactants, they can be utilized alone or by mixing at least two types, and preferably added in a range of 0.001-1.0 weight % against the total ink weight so that the surface tension of ink is arbitrarily adjustable.

In ink according to this invention, inorganic salt may be added in ink to maintain ink viscosity and dye stable and improve coloring. Inorganic salt includes, for example, sodium chloride, sodium sulfate, magnesium chloride and magnesium sulfate. However, this invention is not limited thereto.

In ink according to this invention, an antiseptic agent or an anti-mold agent may be added in ink to maintain long term storage stability of the ink. An anti-septic agent or an anti-mold agent includes, for example, aromatic halogen compounds (such as Preventol CMK), methylene dithiocyanato, halogen-containing sulfur nitride compounds and 1,2-benzisothiazoline-3-one (such as PROXEL GXL).

Cloth having been applied with the above-described ink is successively subjected to a treatment of a coloring process.

A coloring process is a process to develop a hue essential to ink by making dye in ink, which is only attached on the cloth surface after print and is not sufficiently adsorbed and adhered onto cloth, adsorb and adhere onto cloth. As the method, utilized can be steaming by vapor, baking by dry heat, thermo-sol, HT steamer with over-heated vapor and HT steamer with pressurized vapor. They are selected depending on such as a material and ink to be printed. Further, printed cloth may be immediately heated or may be heated after being left for a while provided that the cloth is dried and coloring treated depending on the applications; either method may be applied in this invention.

In an inkjet print method of this invention, in the case of dyeing with disperse dye, carrier may be applied in addition to a method to perform coloring at high temperature. A compound utilized as a carrier is preferably provided with characteristics of large dyeing acceleration, easiness, stability and little load against a human body or environment in the handling, easy removal from fiber as well as no effect on dye durability. Examples of a carrier include phenols such as o-phenylphenol, p-phenylphenol, methylnaphthalin, alkyl benzoate, alkyl salicylate, chlorobenzene and diphenyl; ethers, organic acids and hydrocarbons. These accelerate swelling and plastization of hardly-dyeing fiber, which is hardly dyed at a temperature around 100° C. such as polyester, to make disperse dye penetrate into the fiber. The carrier may be adsorbed in advance on the cloth to be utilized for inkjet print, or may be contained in inkjet ink.

A washing process is necessary after the heating treatment, because stability of color is deteriorated to lower the durability due to the remaining dye which has not participated in dyeing. Further, it is also necessary to remove pre-treatment substances having been applied on the cloth. When they are left as they are, not only decrease of durability but also color change of the cloth may be caused. Therefore, washing is indispensable corresponding to objects to be removed and the purpose. The method is selected according to a material to be printed and ink, and the treatment is performed, for example, by a mixed solution of caustic soda, a surfactant and hydrosulfite. The method is practiced in a continuous mode with such as an open soaper or in a batch mode with such as a solution flow dyeing apparatus; and either method can be applied in this invention.

Drying is necessary after washing. The washed cloth is dried with air or by use of such as a dryer, a heat roll and an iron, after having been squeezed or dehydrated.

### EXAMPLES

In the following, this invention will be specifically explained with reference to examples; however, this invention is not limited thereto. Herein, “part(s)” or “%” represents “weight part(s)”0 or “weight %” unless otherwise mentioned.

<Preparation of Sticky Transport Belt>

[Preparation of Sticky Transport Belt 1]

On the transport surface of an endless belt, BGF-500-10-2 made of Teflon (a registered trade mark) manufactured by Tyuko Chemical Industry Co., Ltd., a double coated sticky tape without a substrate, ARclear 8932 manufactured by Adhesives Research Corp., was pasted up in a style shown in FIG. 5, whereby sticky transport belt 1 was prepared.

[Preparation of Sticky Transport Belt 2]

Urethane sticky tape without a substrate 2 was prepared in a way to coat a thickness of 50 μm of raitotakku PSA-705 representing UV curing urethane-based gluing agent made by Kyoueishakagaku Co. on A50 rainaa made by Teijin DuPont Film Co., by using a blade coater, and then, to irradiate with ultraviolet radiation with 320 mJ/cm2 as an amount of energy, on the surface by using Panakyua NUX323 representing an exposure device made by Matsushita Electric Works, Ltd.

Then, sticky transport belt 2 was prepared in the same way as in the preparation of the sticky transport belt 1 except that the sticky tape was replaced by the urethane sticky tape without a substrate 2

[Preparation of Sticky Transport Belt 3]

Sticky transport belt 3 was prepared in a similar manner to preparation of above-described sticky transport belt 1 except that the sticky tape is changed to a double coated Sticky silicone tape with a substrate, No. 7082 manufactured by Teraoka Seisakusyo Co., Ltd.

[Preparation of Sticky Transport Belt 4]

A thickness of 50 μm of raitotakku PSA-705 representing UV curing urethane-based gluing agent made by Kyoueishakagaku Co. was coated on one side of polyester film E-5107 made by Toyobo Co., Ltd. by using a blade coater, and then, ultraviolet radiation with 320 mJ/cm2 as an amount of energy was irradiated on the surface by using Panakyua NUX323 representing an exposure device made by Matsushita Electric Works, Ltd. On the surface of the Sticky layer thus obtained there was pasted A50 raina made by Teijin DuPont Film Co. Then, a Sticky layer was provided on the reverse side of the polyester film in the same way as in the case of the surface, to prepare urethane sticky tape with a substrate 4.

Then, sticky transport belt 4 was prepared in the same way as in the preparation of the sticky transport belt 1 except that the sticky tape was replaced by the urethane sticky tape with a substrate 2.

[Preparation of Sticky Transport Belt 5]

Sticky transport belt 5 was prepared in the same way as in the preparation of the sticky transport belt 1 except that the Teflon endless belt was replaced by an endless belt E10/MV1/V10 Part Number 900066 made by Nihonjiikring Co.

[Preparation of Sticky Transport Belt 6]

Sticky transport belt 6 was prepared in the same way as in the preparation of the sticky transport belt 1 except that the Teflon endless belt was replaced by an endless belt E12/2 UO/UO Part Number 900040 made by Nihon Jiikuringu Co.

[Preparation of Sticky Transport Belt 7]

Sticky transport belt 67 was prepared in the same way as in the preparation of the sticky transport belt 1 except that the Teflon endless belt was replaced by an endless belt S-10/30 made by Habajitto Nihon Co.

<Preparation of Ink>

[Preparation of Yellow Ink 1]

(Preparation of Yellow Dye Dispersion)

| | |
|---|---|
| Disperse Dye: C.I. Disperse Yellow 30 | 20% |
| Ethylene glycol | 18% |
| Glycerin | 21% |
| Sodium lignin sulfonate | 12% |
| Ion-exchanged water | 29% |

After the above-described additives were successively added and mixed, the mixture was dispersed by use of a sand grinder to prepare a yellow dye dispersion.

(Preparation of Yellow Ink)

| | |
|---|---|
| Yellow dye dispersion | 40% |
| Ethylene glycol | 17% |
| Glycerin | 19% |
| Dipotassium hydrogenphosphate | 2% |
| Potassium dihydrogenphosphate | 2% |
| Anti-septic agent (Isothiazolone chloride) | 2% |
| Ion-exchanged water | 18% |

After the above-described additives were successively mixed and stirred, the mixture was filtered through a 3 μm membrane filter and was subsequently subjected to a degas treatment utilizing a hollow film to prepare yellow ink 1.

[Preparation of Magenta Ink 1, Cyan Ink 1 and Black Ink 1]

Magenta ink 1, cyan ink 1 and black ink 1 were prepared in a similar manner to preparation of the above-described yellow ink except that dye is changed to C. I. Disperse Red 5, C. I. Disperse Blue 330 and C. I. Disperse Black 1, respectively.

<Preparation of Cloth>

Cloths 1-3 having been subjected to a pre-treatment under the following condition were prepared.

Cloth 1: Dyeing test fiber of Shikisensha Co., Ltd. having a ductility of 10%, jersey

Cloth 2: Dyeing test fiber of Shikisensha Co., Ltd. having a ductility of 5%, double pique

Cloth 3: Dyeing test fiber of Shikisensha Co., Ltd. having a ductility of 4%, taffetas.

[Pre-treatment]

| | |
|---|---|
| Calcium chloride dihydrate | 10% |
| Ethylene glycol | 10% |
| Triethylene glycol monobutylether | 5% |
| Pelex OT-P (surfactant, manufactured by | a required amount |
| Kao Corp.) | |
| Ion-exchanged water | a required amount |
| | to make the total |
| | amount to 100 parts |

After the above each additive was successively mixed and stirred, the resulting solution was filtered through a 1 μm filter to prepare pre-treatment solution 1. Herein, the addition amount of Pelex OT-P was adjusted so as to make the surface tension of the pre-treatment solution of 33 mN/m.

Next, each cloth was soaked into the pre-treatment solution, and was squeezed by use of a mangle under a condition of a squeeze ratio of 80%, followed by being dried to prepare pre-treated cloths 1-3.

<Image Recording on Cloth>

[Image Printing]

A solid image was formed under a condition of ink strike quantity (%) described in table 1, by use of an inkjet printer shown in FIG. 3, each sticky transport belt prepared above being mounted in combinations described in table 1 as cloth transport member S, cloth of a 50 m portion having a width of 1.5 m described in table 1 being mounted as roll-form accumulation 50, employing yellow ink 1, magenta ink 1, cyan ink 1 and black ink 1 which have been prepared above. Herein, an ink strike quantity of 100% means an ink quantity required to form a solid image employing ink of one color, and, for example, an ink strike quantity of 400% means that each solid image was formed by being accumulated utilizing all of yellow ink 1, magenta ink 1, cyan ink 1 and black ink

Next, after print on cloth of 50 m had been performed under the above-described condition, new cloths 1-3 of a 10 m portion each were set and printed with a grid image having a 1 cm square size and a 1 mm line width was performed over 1.5 m wide and 10 m long.

[Coloring Treatment and Washing Treatment]

Subsequently, cloth having been printed was subjected to a steaming treatment for 8 minutes at 180° C., being washed with water, and was subjected to a soaping treatment at 40° C., followed by being washed and dried, whereby recoded materials 1-24 were formed.

<Evaluation of Recorded Image>

With respect to each recorded material formed in the above manner and a cloth transport member utilized for formation of the recorded materials, the following evaluations were performed.

[Evaluation of Contamination Resistance of Cloth Transport Member]

With respect to each cloth transport member having been utilized to form each recorded material, performed was visual observation of the presence or absence of contamination and of a corrosion state of the substrate at the surface portion and the pasted up portion (including the cross-section) of a sticky tape, and evaluation of contamination resistance of a cloth transport member was performed based on the following criteria.

A: No contamination on the surface and at the pasted up portion of a sticky tape, and the cross-section is also normal.

B: The surface of a sticky tape is slightly dyed with ink; however, the cross-section is normal.

C: No contamination on the surface of a sticky tape; however, the pasted up portion and the cross-section are deformed and ink has penetrated therein.

D: The surface of a sticky tape is dyed with ink and there is observed strong deformation at the pasted up portion and the cross-section, and ink has penetrated therein.

[Evaluation of Grid Reproducibility]

Grids of 100 pieces which have been printed on the pasted up portion were randomly extracted, and the deformed state of dimension was visually observed to evaluate grid reproducibility based on the following criteria.

A: No generation of disorder of the grid is recognized with respect to the all of 100 grids.

B: Disorder is recognized with 1-3 pieces among 100 grids.

C: Distinct disorder is recognized with not less than 4 pieces among 100 grids.

[Evaluation of Back-Surface Contamination Resistance]

The contamination state of the back surface of the cloth, which has performed printing of the above-described grid image, was visually observed, and back surface contamination resistance at an image printed portion was evaluated.

A: No generation of back surface contamination.

B: Slight contamination on the back surface is observed, however, it is not problematic in a practical use.

C: Weak transfer of ink on the sticky transport belt onto the back surface of the cloth is observed, however, it is allowable in practical use.

D: Strong transfer of ink on the Sticky transfer belt onto the back surface of the cloth is observed and it is problematic quality in practical use.

[Evaluation of Image Bleeding Resistance]

With respect to a grid image, having a line width of 1 mm, formed according to the above-described method, the grid line width was measured to evaluate the image bleeding resistance based on the following criteria.

A: No increase of the line width of the grid is observed at all.

B: A slight increase of the line width of the grid is observed, however, it is allowable in practical use.

C: Bleeding of the grid is generated to distinctly increase the line width.

The evaluation results obtained above are shown in table 1.

TABLE 1

| | Sticky transport belt | | | | | | Result of each evaluation | | | | |
|---|---|---|---|---|---|---|---|---|---|---|---|
| | | | adhesive double | | | | Contamination | | | | |
| | | | coated tape | | | Ink | resistance | | Contamination | | |
| Recorded | | | Presence or | | | strike | at cloth | | resistance | Image | |
| material | | Belt | absence of | | Cloth | quantity | transfer | Grid | of back | bleeding | |
| No. | No. | Material | substrate | Material | type | (%) | member | reproducibility | side | resistance | Remarks |
| 1 | 1 | Teflon | No | Silicone | 1 | 400 | A | A | A | A | Inv. |
| 2 | 1 | Teflon | No | Silicone | 1 | 300 | A | A | A | A | Inv. |
| 3 | 1 | Teflon | No | Silicone | 1 | 200 | A | A | A | A | Inv. |
| 4 | 1 | Teflon | No | Silicone | 1 | 100 | A | A | A | A | Inv. |
| 5 | 2 | Teflon | No | Urethane | 1 | 400 | D | C | D | A | Comp. |
| 6 | 2 | Teflon | No | Urethane | 1 | 300 | D | C | D | A | Comp. |
| 7 | 2 | Teflon | No | Urethane | 1 | 200 | D | C | D | A | Comp. |
| 8 | 2 | Teflon | No | Urethane | 1 | 100 | D | C | D | A | Comp. |
| 9 | 3 | Teflon | Yes | Silicone | 1 | 400 | C | C | A | B | Comp. |
| 10 | 3 | Teflon | Yes | Silicone | 1 | 300 | C | C | A | A | Comp. |
| 11 | 3 | Teflon | Yes | Silicone | 1 | 200 | C | C | A | A | Comp. |
| 12 | 3 | Teflon | Yes | Silicone | 1 | 100 | C | B | A | A | Comp. |
| 13 | 4 | Teflon | Yes | Urethane | 1 | 400 | D | C | D | B | Comp. |
| 14 | 4 | Teflon | Yes | Urethane | 1 | 300 | D | C | D | A | Comp. |
| 15 | 4 | Teflon | Yes | Urethane | 1 | 200 | D | C | D | A | Comp. |
| 16 | 4 | Teflon | Yes | Urethane | 1 | 100 | D | B | D | A | Comp. |
| 17 | 1 | Teflon | No | Silicone | 2 | 400 | A | A | A | A | Inv. |
| 18 | 1 | Teflon | No | Silicone | 2 | 300 | A | A | A | A | Inv. |
| 19 | 1 | Teflon | No | Silicone | 2 | 200 | A | A | A | A | Inv. |
| 20 | 1 | Teflon | No | Silicone | 2 | 100 | A | A | A | A | Inv. |
| 21 | 1 | Teflon | No | Silicone | 3 | 400 | A | A | A | B | Inv. |
| 22 | 1 | Teflon | No | Silicone | 3 | 300 | A | A | A | B | Inv. |
| 23 | 1 | Teflon | No | Silicone | 3 | 200 | A | A | A | A | Inv. |
| 24 | 1 | Teflon | No | Silicone | 3 | 100 | A | A | A | A | Inv. |
| 25 | 5 | PVC | No | Silicone | 1 | 400 | A | C | A | A | Comp. |
| 26 | 6 | Urethane | No | Silicone | 1 | 400 | A | C | A | A | Comp. |
| 27 | 7 | NBR | No | Silicone | 1 | 400 | A | C | A | A | Comp. |

It is clear from the results described in table 1 that a recoded material formed employing a sticky transport belt of this invention, in which a sticky tape without a substrate is applied on the surface of an endless belt, is excellent in grid reproducibility and back surface contamination resistance, compared to comparative examples. Further, it is also clear that a sticky transport belt of this invention is superior in contamination resistance as a transport member. Further, it is clear that image bleeding resistance is furthermore improved by utilizing cloth having a ductility at a breaking point of not less than 5%.

What is claimed is:

1. An inkjet printer, comprising:
a conveying section to holding and conveying a recoding material, and
an ink jet print head to jet an ink for the recoding material;
wherein the conveyance section has an endless conveying member including an endless base member whose outer peripheral surface is covered with fluororesin and a sticky layer formed by a sticking tape transferred onto the outer peripheral surface of the endless base member, the sticking tape has not a substrate and the sticky layer contains a silicone polymer.

2. The inkjet printer of claim 1, wherein the silicone polymer is an addition reaction curing type silicone polymer.

3. The inkjet printer of claim 2, wherein the addition reaction curing type silicone polymer contains (A) polydiorganosiloxane having two or more alkenyl groups in one molecule and (B) polyorganosiloxane having a SiH group and a blending ratio of the components (A)/(B) in terms of weight is 20/80 to 80/20.

4. The inkjet printer of claim 2, wherein the addition reaction curing type silicone polymer contains (A) polydiorganosiloxane having two or more alkenyl groups in one molecule and (B) polyorganosiloxane having a SiH group and a mole ratio of the SiH group in the component (B) relative to the alkenyl group in the component (A) is 0.5 to 20.

5. The inkjet printer of claim 1, wherein the recording material is a fabric.

6. The inkjet printer of claim 1, wherein an elongation at break in a longitudinal direction and a transverse direction of the fabric is 5% or more.

7. The inkjet printer of claim 1, wherein the ink contains dispersion dye as a coloring material.

8. The inkjet printer of claim 1, wherein the an endless base member is one of an endless belt or a roller.

9. A recording material, produced by the inkjet printer of claim 1.
